(19) United States
(12) Patent Application Publication
(10) Pub. No.: US 2015/0068116 A1
(43) Pub. Date: Mar. 12, 2015

(54) Vineyard configuration

(71) Applicant: James K. Bullis, Sunnyvale, CA (US)

(72) Inventor: James K. Bullis, Sunnyvale, CA (US)

(21) Appl. No.: 13/987,853

(22) Filed: Sep. 9, 2013

(51) Int. Cl. A01G 17/04; B62D 49/00

(52) U.S. Cl. CPC A01G 17/04; B62D 49/00
USPC 47/44; 280/29; 800/298

(57) ABSTRACT

Here invented is a vineyard configuration for maximizing use of the resources of land and sun. It is a configuration based on a low and narrow tractor that enables both narrow spacing of rows of plants in vineyards and formation of canopies that enable nearly complete usage of impinging sunlight.

This patent document contains material that is subject to copyright protection. Facsimile reproduction is allowed of the patent document or the patent disclosure as it appears in the Patent and Trademark Office patent file or records as allowed by US patent law, but otherwise all copyright rights are reserved.

### BACKGROUND OF THE INVENTION

1. Field of the Invention

This present invention relates to agricultural operations.

2. Description of the Prior Art

Two years ago an invention was disclosed that addressed the need to support field workers doing manual labor. In the course of writing that initial application it appeared that there might be vineyard applications, though the scale of such was not determined at that time. Through the course of building and testing that invention, it has been established that a tractor of a size based on the size of the typical worker would be possible, and further, it would be about the best that could be done given that a real person was to be the worker. Now it seems appropriate to approach the agricultural system design from the other direction, that being to fit the plants and vineyard layout to the tractor.

There is substantial authority saying that wine is very good from vines that are sized according to a fixed vigor that a grape producing plant can muster. Considerable variation of opinion exists on this point, but it appears that there is opportunity for much better use of land without compromising quality or individual plant yield, meaning planting density might well be much higher than the usual practice. If a change like this is made, the produce from a given acreage can be greatly increased.

Looking at the reasons for present planting density seems to show that the available tractors have been more the basis for decisions than anything related to wine quality or yield of a vineyard acre. Considerable effort has been put into meeting a need for a much narrower tractor, though it looks like imaginations are limited when it comes to tractors, and we are still stuck on the pneumatic tire mounted on a frame with the operator riding above the machinery and the machinery fitted between wheels. Not only does this mean the planting width is wide, the canopy has to be managed to allow a high vehicle to pass through a row space. Even tractors such as some by Caval and Bobard, that purport to enable a return to traditional narrow planting involve a high vehicle that prevents use of canopy configurations that are efficient in capture sunlight. Going further, even the horse is shaped to force some open space between vines. So the result has been that much of the agricultural resource has been and still is being left unused. One can look at many available pictures and analyze the shadows to see much effort is being put into ‘growing dirt’, to put it somewhat sharply.

If it must be that there be space for a vehicle to pass, even a narrow vehicle, then existing tractor height dictates that canopy shape must be more vertical than horizontal. Once this step has been taken, the concern to arrange for adequate sunlight by wide spacing between rows makes sense. Adequate sunlight capturing leaf area for vine support from vertical foliage means that rather a lot of foliage is needed, since most of it only captures sunlight part of the time. So not only is the pruning done for vertical canopy arrangement, tall pruning is practiced to give the necessary leaf area. Of course, tall pruning drives the vineyard manager to use wide inter-row spacing to avoid shadowing of adjacent rows. Tall pruning works to produce very good wine, but it might not be the best way from a land use perspective. All this established practice makes sense where it is limited by existing machine technology.

So the present task is to configure a vineyard to fit a machine that is the lowest and narrowest apparatus possible for carrying a worker.

It appears that it also makes sense to utilize vineyard plants that are modern varieties with planting, pruning, and training that matches their vigor.

Trellis arrangements are known as in U.S. Pat. No. 6,557,335 Amaro et al. 2003 where vines are trained to allow full sized tractors to pass underneath as shown in FIG. 8 of that invention, but these necessitate large plants, which are here understood to be of size to be avoided for quality wine grape production. Horizontal training of vines is shown in U.S. Pat. No. 5,272,834 Jarahian 1993 but the purpose of apparatus there is to make wide plant spacings functional.

### SUMMARY OF THE INVENTION

Newly discovered is a novel, new vineyard configuration adapted to utilize a new tractor configuration. Effective utilization of land and sun resources and effective usage of limited vigor of plants indicate very different vineyard design. The co-invented machines that are Ser. No. 13,199,968 Bullis 2011, Ser. No. 13/506,181 Bullis 2012, and Ser. No. 13/506,304 make this a practical new way to farm.

It has been shown that a tractor that puts the worker seat close to the ground can be made stable and efficient in a width of about 26 inches and with a wheel contact surface of about 20 inches. The essential height of this tractor is about 42 inches, but the top of the worker's head is about 48 inches above ground.

A vineyard configuration adapted to this tractor provides for a passage-way for this or any tractor of approximately these dimensions. For best use of land area, the passage-way is bounded at the sides. The desirable, efficient vineyard configuration provides no more side clearance room than necessary for maneuvering the vehicle. By keeping the inter-row space as small as possible, with whatever is needed for intra-row spacing for plant health, land is fully used. For best use of plant vigor, the passage-way is bounded above with head room and working room provided that is no more than needed.

A particular feature of such an efficient vineyard is a canopy that overhangs the passage-way in such an arrangement that maximizes sunlight duration on leaves of the foliage. A horizontal surface presents most upper leaves to the sun nearly all day. With pruning and training that allows few leaves that are not positioned for effective sunlight capture the canopy becomes thin. With this agricultural practice, vigor of the plant is not wasted in developing more foliage than necessary. Further, pruning and training results in a nearly closed gap over the row space, such that just before harvest, this vineyard configuration will stop sunlight from reaching the ground. Ideally, the ground will be entirely in shadow.

### BRIEF DESCRIPTION OF THE DRAWINGS

FIG. 1 (prior art) Narrow tractor concept for placing a worker in a favorable work position, shown in a vineyard of non-specific scale

FIG. 2 (prior art) Canopy removed for one row to show tractor in more detail, and also to show fruit growing zones

FIG. 3 Tractor with lower frame that resulted from concept development and testing, with specific dimensions and implications for vineyard row space dimensions

FIG. 4 Canopy configuration for complete sun capture, with sizes that fit validated tractor dimensions

FIG. 5 Canopy control provisions in place with respect to canopy

### DETAILED DESCRIPTION

It looks like there could be an emerging high technology in agriculture, where we might see real departure from traditional ways of using land. While it appropriate to be careful about this kind of change, the need to greatly increase productivity should drive us to look for better ways.

One of the most remarkable things about vineyard practice is that most of it involves planting configurations that leave much of the ground idle. Roots extend quite a lot, but it can be seen in irrigation arrangements that root ball widths more than about a meter would go beyond water supply zones. This suggests that root space does not justify wide row spacing. Where rain water is significant, and where cover crops are used, a study has shown that roots of the cover crop capture moisture and roots of vines seek moisture from areas not under the cover crop, and this also suggests that the cover crop space might sometimes be of little value. There are benefits of cover crops, but were the rows closer together, maybe not as much as generally thought.

Most realize that the ultimate decision about row spacing depends on the width of available tractors. This is of course good sense, but it also makes sense to try to do better. Production tractors are generally wide because they are designed for stability which comes from widely spaced tire tracks. Maybe not fully realized is the effect of these heavy machines, where pressure caused below ground is hard-pan generating, and this, repeated over time can be a cause of serious degradation of the field. A question might be whether this is why American vineyards are said to have useful life of about 27 years. Another question is whether the great horse caused this kind of soil damage which might explain some of the need to leave fields to lie fallow.

The tractor involved with this invention is built to limit this damage with its large area footprint holding up a light weight vehicle.

A simple but penetrating analysis of vineyards from satellite photography, as well as much publicity photography, shows that a lot of sun energy is wasted in direct impact with the ground. If there is any point in warming the ground, it is not so important that vineyards be arranged for this. The present invention arranges to capture most sun benefit with well configured foliage, where the leaves in canopies stop the sun from ground warming. This arrangement involves overhead canopies. The standard tractor is contrary to this also, and though overhead canopies are known where they are large enough for passage of a standard tractor configuration there are reasons to avoid large plants if high quality wine grapes are to be grown.

World vineyard operations for growing wine grapes are generally involved with small vines where pruning is done to establish a fruit zone that is within reach of a worker standing or kneeling on the ground. Viticulturists discuss plant vigor as being approximately fixed for a particular plant of a given variety. This vigor must be channeled for development of root structure, foliage, and grapes themselves. They say that a plant that develops too much foliage can produce watery and less flavorful grapes. Pruning instructions bear this out. This experience argues for not setting up a vineyard for large vines. Consequently, it appears that to establish a vineyard with overhead canopies, the canopies need to be lower than would be possible where a standard tractor with seat well above the largest wheel axis and a rider sitting upright on the seat was the basis for sizing the canopy. Even if the standard tractor were made narrow, down to 30 inches wide, the overhead clearance would be much higher than that required for the narrow and low tractor involved here. The new provision for the worker to sit very close to the ground enables a whole new shape for plants.

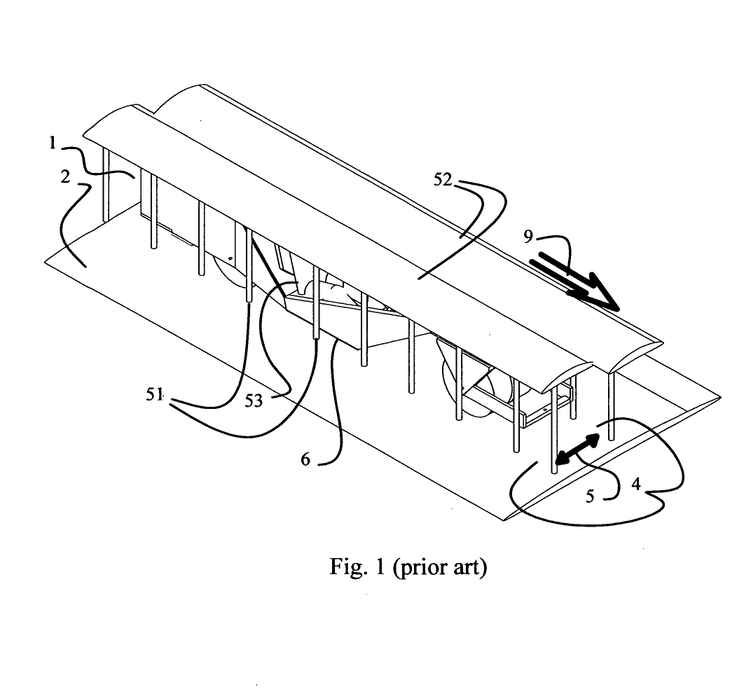

Prior art is explained in FIG. 1 where a concept vehicle is shown in a vineyard setting, with a ground section shown 2. The concept vehicle 1 addressed the need to put a worker 53 in easy reach of low growing crops, so the worker seat allowed a very low position. The vehicle width 5 was such that it could fit between rows 4 and travel with forward direction indicated 9. Ground clearance 6 was sufficient for field work. Non specific vegetation 52 was shown for perspective purposes. At time of writing this earlier application it was not known that vegetation 52 shown here was virtually non-existent in vineyard practice.

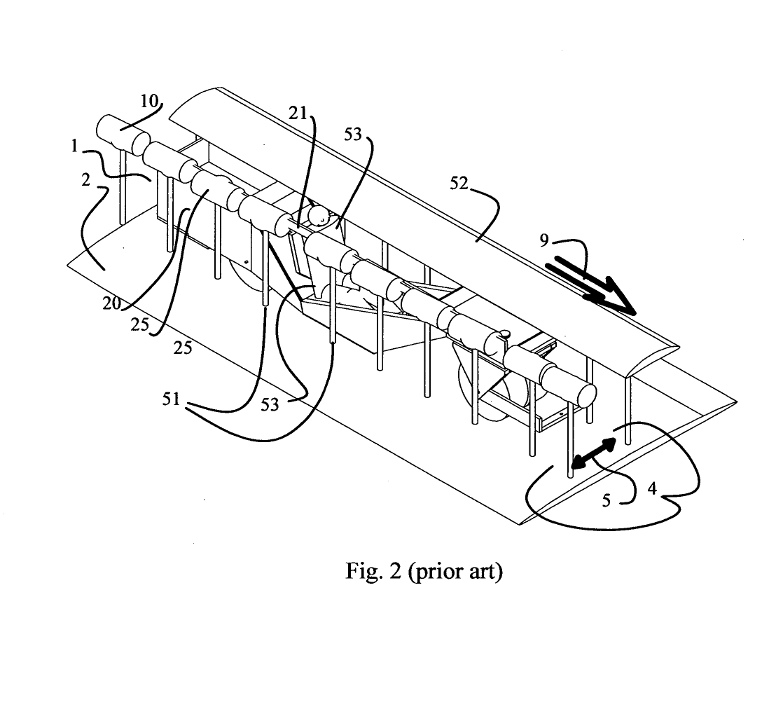

Prior art is further explained in FIG. 2 where the previous concept vehicle 1 is shown to enable detail viewing. The field surface 2 is as before. Worker placeholder 53 is now visible. Vineyard plant trunks 51 are now visible in rows 4 that are very close to sides of vehicle 1. Only part of representative upper vegetation 52 remains. This vehicle was constructed to be as light as possible with frame 20 being of a unit body nature with a box frame having upper beams 21 to provide rigidity without excessive weight. Having removed part of the upper vegetation 52, fruiting zones 10 are depicted that were not specified in the prior art document.

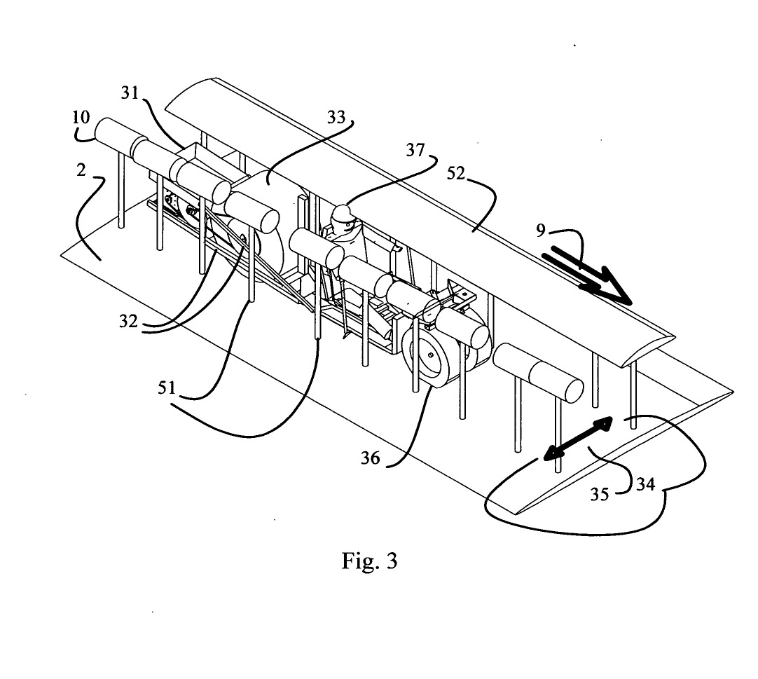

The vehicle concept shown in prior art was at that time defined in terms of relationships of its parts, without specificity as to absolute dimensions. FIG. 3 is now presented on the basis of the resulting concept vehicle 31. The present width 35 now determines position of the rows 34 necessary to allow vehicle passage. Front wheels 36 are now shown with rigid surfaces like the rear wheel surface, and rear wheel 33 is large with a diameter of 38 inches. Vegetation 52 from prior art is now shown interfering with head 37 of worker placeholder which is now a little larger than previously shown.

FIG. 3 also shows the lowered frame structure 32 that was introduced to aid worker visibility as well as implement a significant center of gravity lowering improvement. The rear wheel 33 is shown without its safety cover which is now made of light gauge steel on a minimal frame for ridgidizing effect.

Implementation of the prior art invention proceeded with broad applications in mind, but were generally addressing the need to help field workers do work on low growing crops. It gradually became known that a more specific target market was needed, and growth trends in the vineyard market made that an obvious choice, as did living not far from famous wine growing regions. Surprising resistance was encountered which made it appropriate to address vineyard topics in detail. As a result, it was discovered that more of vineyard design project was required that went beyond simply suggesting narrow spacing as a way to achieve large profit gains by using the narrow vehicle. In competing with existing practice it seemed useful to suggest use of European traditional methods, which included narrow rows. But European vineyard operators seemed to be also facing labor cost issues, and mechanization there was also desired.

European mechanization included over-the-row tractors which also enabled narrow row space, and though these tended to be expensive, they seemed to make our narrow tractor less than absolutely necessary. But there is something very different about the narrow vehicle for in-row operation, that being that the low seated worker meant that the overhead clearance was also low. This is a feature that having dramatic advantage compared to the over the row tractors, or even the noble horse. This all came together after observing photographs and satellite imagery where shadows on the ground were very small compared to the otherwise sunlit ground. “Growing Dirt” is not the right way to effectively utilize land.

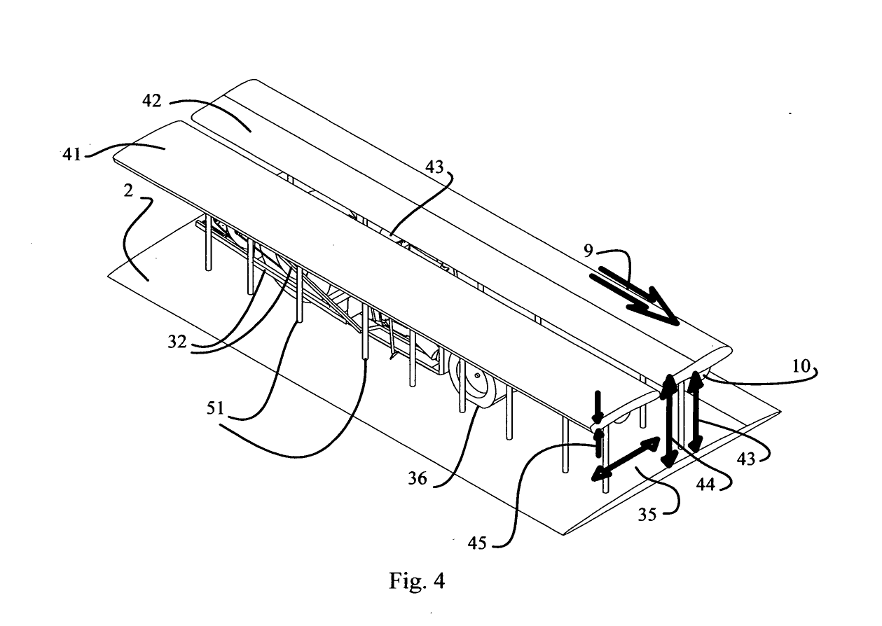

FIG. 4 shows the vineyard configuration that specifically answers this challenge. Canopies 41, 42 specifically provide nearly full sun capture over a single surface of leaves that are appropriately directed. Leaves on this surface function throughout the sunlight duration. For those that use tall vehicles, whether they are standard tractors, Cavals, Bobards, or horses, this configuration is not possible. In contrast, the prior art tractor and successors to put a worker low, are by nature also very low. So such would work effectively under the canopies 41,42 as shown. Without the low tractor, nobody could like the canopy design shown here. But surprisingly, European tradition could be significantly improved on using the low and narrow tractor now available.

FIG. 4 shows realism of a gap 43 between canopies but worker placeholder head is not interfering with canopy of this presently specified invention. Fruiting zone 10 is positioned under the canopy, which may be adjusted to allow sun penetration to grape clusters as directed by experienced pruners.

Canopy clearance 43 and height of sun capture surface are now shown. A thin 45 canopy feature is also important for minimizing non-functional vegetation. Leaves doing little for sun capture are removed to establish and maintain this thin dimension.

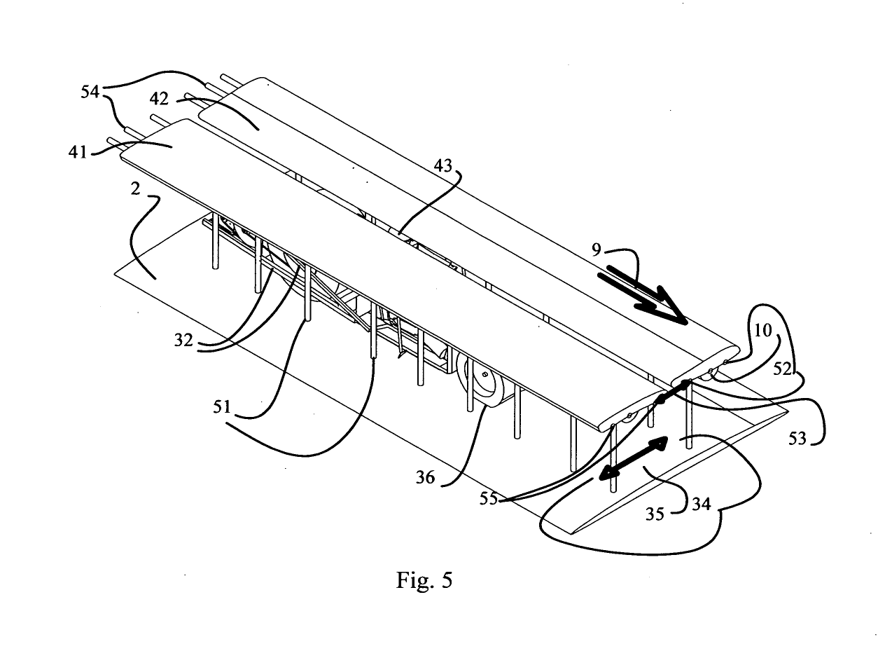

FIG. 5 shows the same canopy arrangements with canopy support wires 55,52 and fruit zone control wires 54. The canopy support wires function in combination with support structures that the wires are attached to as foliage develops; starting with the wire being free at the beginning of the growing season but then being lifted to raise the canopy to its horizontal configuration with the needed clearance underneath. Space between control wires 53 is approximately 20 inches to enable a worker to stand or ride between these wires as canopy development takes place. The fruit zone control wires 54 are variably useful depending on the style of pruning.

The invention here described is in terms of a system that enables manual farm work. However, the scope of the invention includes, in particular, robotic versions of equipment here discussed.

The scope of the invention is to be defined by the appended claims.

I claim:

1. A field with plants in a configuration to maximize crop value, where said plants are arranged in rows with passage space between said rows that is no wider than needed for passage of a vehicle that is less than 40 inches in width at its widest point, where maximizing of crop value is enabled by effective capture of direct sun energy, where a sun capture surface area is an upper side of a canopy that is configured horizontally to enable sun energy capture over a sun angle extent of more than 120 degrees.

2. A field according to claim 1, where said canopy is from plants in adjacent rows and growth of canopies reaches a state of near closure at its most developed stage such that a gap is left in said canopy no greater than 20 inches.

3. A field according to claim 1, where said canopy is from plants in adjacent rows and growth of canopies reaches a state of near closure at its most developed stage such that a gap is left in said canopy no greater than 6 inches.

4. A field according to claim 1, where said vehicle is less than 30 inches.

5. A field according to claim 1, where said canopy is an upper boundary of said passage space that is less than 60 inches above ground.

6. A field according to claim 1, where said canopy is an upper boundary of said passage space that is less than 50 inches above ground.

7. A field according to claim 1, where said canopy is a canopy having an approximately flat upper surface.

8. A field according to claim 1, where said canopy is a thin canopy which is thinned to remove leaves that provide less than 10% directly sun exposed area over 90% of the duration of said sun angle extent.

9. A field according to claim 1 that includes canopy training wires that aid in establishing a horizontally growing canopy.

10. A field according to claim 1 that includes fruit zone support wires.

11. A field and vehicle combination, where said field includes plants arranged in rows spaced to enable passage of said vehicle, where said vehicle includes a frame with attached front and rear wheels, and where said frame is a low frame that enables a center of gravity of said vehicle that is lower than an axis of the smallest of said front and rear wheels.

12. A field and vehicle combination according to claim 11 where said field is configured for maximize capture of direct sunlight, where canopies of adjacent said rows grow mutually toward each other to form an approximately flat, horizontal, surface to enable sun energy capture over at least 80% of the area between rows over at least 6 hours a day of continuously clear sun conditions.

13. A field and vehicle combination according to claim 11, with canopy control wires that support growing canopies, where canopies do not reach said wires after their closest pruning, where said plants produce canopies that grow to enable training where canopy foliage is held by said wires in a horizontal arrangement that establishes a horizontal upper surface that is capable of capturing direct sunlight energy over a sun angle extent of 120 degrees.

14. A field and vehicle combination where said vehicle is equipped to operate without an operator being present on said vehicle.

15. A vineyard, where plants of a species are arranged in said vineyard in rows, and growth of said plants is controlled to establish a canopy between rows, where there is a characteristic vigor of said plants that is fixed for that species, where said vigor is preserved for fruit development due to a limit to plant dimensions of said vineyard, where said limit is defined as a sum of row spacing in inches and canopy height in inches, and said limit is less than 120 inches.

16. A vineyard according to claim 15, where said limit is 96 inches.

17. A vineyard according to claim 15, where said vineyard has a ground surface area that is at least 80% shadowed.

18. A vineyard according to claim 15, that includes canopy training wires that attach to trellis structures such that said wires hold said canopy in a horizontally growing configuration.

19. A vineyard according to claim 15, that includes canopy training wires and trellis structures, where said wires are arranged to enable upward movement to lift said canopy to enable formation of a thin said canopy, where said trellis structures enable said wires thus moved to be attached to said trellis structures.
